(19) United States
(12) Patent Application Publication
(10) Pub. No.: US 2012/0002084 A1
(43) Pub. Date: Jan. 5, 2012

(54) SYSTEMS, APPARATUS, AND METHODS FOR DIGITAL IMAGE CAPTURE WITH VARIABLE DENSITY DISPLAY AND HIGH RESOLUTION ELECTRONIC ZOOM

(75) Inventors: Michael A. Weissman, Santa Barbara, CA (US); George C. Polchin, Santa Barbara, CA (US)

(73) Assignee: TRUE VISION SYSTEMS, INC., Santa Barbara, CA (US)

(21) Appl. No.: 12/828,074

(22) Filed: Jun. 30, 2010

(51) Int. Cl. H04N 5/262

(52) U.S. Cl. 348/240.2; 348/E05.055

(57) ABSTRACT

Disclosed herein are systems, apparatus, and methods for real-time image capture with variable density display, high resolution electronic zoom, and improved depth of field. The systems, apparatus, and methods used to view a target site include: at least one image sensor with an energy receiving surface having X pixels for producing one or more signals that correspond to the target site; at least one display for presenting N fields of view, wherein each field of view is comprised of at least one image produced by the signals; and an electronic zoom mechanism that can switch between N fields of view with little or no loss of resolution, wherein the first field of view is comprised of input from no more than X/N non-adjacent pixels and at least one zoom field of view is comprised of input from no more than X/N adjacent active pixels.

### BACKGROUND

The use of digital imaging can greatly enhance accuracy and productivity in fields where fine detail needs to be perceived, such as in surgery or other medical procedures, molecular, cellular, or biological research, navigation or mapping, astronomy, microprocessing, or micro-assembly. In particular, the ability to magnify a field of view or a part thereof by zooming in on a particular feature can assist visualization of a target site, such as a target surgical field, and thereby substantially improve precision.

However, to date, digital imaging devices used during surgery, particularly microsurgery, and many other fields have typically only provided digital zooming capability and traditional, non-electronic optical zooming capability that is dependent on the varifocal lens used. Digital zooming is accomplished by enlarging a portion of a field of view to a desired size without adding extra pixels or detail. As a result, in magnification by digital zoom, the number of pixels of the digital zoom field of view is the same as the number of pixels in that portion of the original broad field of view. As such, when the images are displayed, there are fewer pixels in the digital zoom field of view than in the original broad field of view. For example, if an original broad field of view of 1280×1024 pixels (or 1.3 megapixels) is digitally zoomed by a factor of two in each of the horizontal and vertical directions, the digital zoom field of view has only 640×512 pixels (or 0.3 megapixels).

Given today's technology, the further the broad field of view is digitally zoomed-in, the less detail there is in the resulting image, and the less accurate the representation of the target site becomes. In some instances the loss of resolution means that important features of the target site may be obscured or distorted in the digital zoom field of view. Consequently, the lower resolution of a digital zoom field of view may be problematic where precise visualization of a target site is necessary, such as in microsurgery, cellular research, or cartography.

Furthermore, when the optics of a microscope, telescope, or binoculars are zoomed in, the depth of field is significantly decreased. For example, when the optics of a microscope are zoomed in two and half times, the depth of field typically decreases by at least fifty percent. As such, the scope of the field of view that appears sharply in a zoom microscope view is restricted. Therefore, the zoom microscope view has limited utility for visualizing a target site that has features at a variety of depths or distances, such as target surgical field. Moreover, the low depth of field in a zoomed-in microscope view makes navigation within that field of view difficult because of the lack of clarity of features at varying depths.

Zoomed-in images from imaging devices typically suffer from either the loss of resolution caused by digital zooming or the reduced depth of field that results from zooming in microscope, binocular, or telescope optics, or both. In addition, optical zoom necessitates a loss of light intensity and a loss of visible resolution. Accordingly, in spite of the ongoing development and the growing sophistication in camera optics, particularly those used in the surgical theater, there remains a need for improvement in the resolution and depth of field of magnified images.

### SUMMARY

The exemplary embodiments and methods of the present description produce real-time video or still images which can be quickly magnified or zoomed-in with little or no loss of resolution and/or reduced depth of field loss. By sub-sampling a higher-resolution sensor down to the resolution of a display, the exemplary embodiments keep the resolution of the sub-sampling substantially the same as an image is zoomed-in, and accordingly create a pixel-accurate display. Resolution of the electronically zoomed images is maintained because the original, broad first field of view is comprised of signals from non-adjacent active pixels, and the zoom fields of view, such as the second and third fields of view, are comprised of signals from non-adjacent active pixels or adjacent active pixels. In some embodiments and methods, the aspect ratio (width divided by height) is also maintained substantially the same for each field of view. In addition, the images produced by the exemplary embodiments and methods of the present description can be micro-navigated without refocusing.

The apparatus for producing such images in accordance with the teachings of the present description is a simplified high-resolution electronically-zoomable real-time image capture system with a variable density display that includes at least one image sensor for producing one or more video or still image signals, at least one display for presenting one or more video or still images of a defined number (N) of fields of view derived from the signals, and an electronic zoom mechanism for switching between a broad first field of view and one or more zoom fields of view, such as a second and/or third field of view. The image sensor and signals can be controlled by one or more processors, which can also process and transport signals and image data for display.

The associated method of electronic zoom includes first producing a defined number of fields of view presented by at least one display, where each field of view is an image derived from at least one signal produced by one or more image sensor having an energy receiving surface with a defined number of pixels. The method also includes switching between a first field view generated from input from a portion of non-adjacent active pixels of the energy receiving surface and one or more zoom fields of view generated from input from a portion of adjacent active pixels or non-adjacent active pixels of at least one specific area of said energy receiving surface. The pixels producing the one or more signals for the zoom field(s) of view are closer together than the pixels for producing the signals for the first field of view.

Furthermore, the exemplary embodiments and methods of electronic zooming between a broad first field of view and at least one zoom field of view described herein can provide a real-time digital stream of video or still images, including those that would typically be seen through a microscope.

The at least one image sensor has an energy receiving surface with a defined number of pixels (X) (for example, X may be, but is not limited to, 4.95 megapixels or 2560×1944 pixels). The first field of view signals and the one or more zoom fields of view signals are comprised of input from a portion of that defined number of pixels that is no greater than X/N active pixels. In some embodiments, the portion of the defined number of pixels can be less than X/N, for example about X/N². For example, without limitation, if there are two fields of view (N=2), each of those fields of view can be comprised of about one quarter of the defined number of pixels (X/4), or if there are ten fields of view (N=10), each of those fields of view can be comprised of about one hundredth of the defined number of pixels (X/100). The active portion of the pixels (X/N) yielding input for the first or zoom fields of view signals can be, but is not limited to being, distributed evenly across the array.

In order for the first field of view images and zoom fields of view images to have substantially the same resolution, the first field of view signals are produced by non-adjacent active pixels of the energy receiving surface, but the zoom fields of view signals—such as the second and/or third, fourth, or fifth field of view signals—are produced by adjacent active pixels of at least one specific area of the energy receiving surface or non-adjacent active pixels closer together than the non-adjacent active pixels producing the first field of view signals. In some embodiments, input for a field of view from non-adjacent active pixels can be comprised of average signals, where each average signal is a mean signal from an active pixel and its adjacent non-active pixels (i.e., the signals from the pixels are binned).

The image capture apparatus and methods of the present description can be used to view and produce video or still images of a target site. A target site can include sites visualized with the apparatus, including, but not limited to: a surgical site; a site for a medical or dental procedure; a site used in cellular, molecular, or biological research; an astronomical site such as stars, planets, or asteroids; a mapping or cartographical site; an underwater site; a site with low-visibility; a micro-assembly site; a wildlife- or bird-viewing site; or a long distance scenery site.

Further, the simplified high-resolution electronically-zoomable real-time image capture apparatus with a variable density display of the present description can include at least one electronic panning mechanism for varying the location of the fields of view, for example the second and/or third zoom field of view.

The apparatus described herein can also include a second image sensor with a second energy receiving surface of a defined number of pixels (for example, at least 4.95 megapixels (e.g., 2560×1944)) for producing one or more additional signals. Video or still images derived from the additional signals produced by the second image sensor can provide different angles, perspectives, or views of the target site than those images derived from the video signals from the first image sensor.

Additionally, the video or still image signals produced by the apparatus' one or more image sensors can be in high definition (HD) and/or three dimensional (3D) format. Further, the one or more images can be refreshed at a rate of at least 20 frames per second.

In accordance with the teachings of the present description, the electronic high-resolution image capture apparatus with variable density display can be a stand-alone device, or in other embodiments it can be mounted to existing equipment including, but not limited to, a microscope, for example a surgical microscope or stereomicroscope.

### BRIEF DESCRIPTION OF THE DRAWINGS

FIG. 1 illustrates an exemplary image capture module of the present description.

FIG. 2 illustrates an exemplary image capture module of the present description retrofitted to a surgical microscope.

FIG. 3 illustrates an exemplary optical mount to fit an exemplary image capture module to microscopes or other existing equipment such as telescopes.

FIG. 4 is an exemplary schematic overview of a broad first field of view and a zoom field of view wherein the first field of view is comprised of a certain number (X/N) of non-adjacent active pixels and the zoom field of view is comprised of no more than X/N adjacent active pixels.

FIG. 5 is a different exemplary schematic overview of a broad first field of view and a zoom field of view wherein the first field of view is comprised of a certain number (X/N²) of non-adjacent active pixels and the zoom field of view is comprised of the same number (X/N²) of adjacent active pixels.

FIG. 6 is an exemplary schematic overview of a broad first field of view and two zoom fields of view.

FIG. 7A illustrates a broad first field of view comprised of non-adjacent active pixels, FIG. 7B illustrates a zoom field of view comprised of non-adjacent active pixels closer together than the non-adjacent pixels of the broad first field of view, and FIG. 7C illustrates a zoom field of view comprised of adjacent active pixels.

FIGS. 8A, 8B, and 8C are exemplary schematics of a broad first field of view and two zoom fields of view. FIG. 8A illustrates an exemplary embodiment in which input from non-adjacent active pixels for a first field of view signal is comprised of average signals from a portion of non-adjacent active pixels and their adjacent non-active pixels. FIG. 8B illustrates an embodiment in which input from non-adjacent active pixels for a zoom field of view signal is comprised of average signals from a portion of non-adjacent active pixels and their adjacent non-active pixels, wherein the non-adjacent active pixels are closer together than those in FIG. 8A. FIG. 8C illustrates a zoom field of view comprised of adjacent active pixels.

FIG. 9 is an exemplary schematic overview of the panning capability of a zoom field of view of the present description.

### DETAILED DESCRIPTION

The use of digital imaging can greatly enhance precision and accuracy in detail-oriented fields, such as surgery, medical or dental procedures, microprocessing/micro-assembly, cellular, molecular, or biological research, navigation, mapping, or the like. It has become commonplace for digital imaging devices such as video cameras, single-lens reflex (SLR) cameras, point and shoot cameras and the like to be utilized either alone or coupled to sophisticated medical or surgical equipment to aid the surgeon, surgical team, medical practitioner, or medical team in imaging of a target site, such as a target surgical field. In addition, digital imaging with high-resolution zoom can be an advantageous tool in cellular, molecular, or biological research, astronomy, mapping or cartography, microprocessing/micro-assembly, or navigation. Moreover, digital image capture apparatus and/or zooming technology can be used in conjunction with touch screens, mobile phones, binoculars, telescopes, and microscopes. Zooming technology can also provide for more accurate visualization of low-visibility or long distance target sites such as those in underwater, scenery, or wildlife or birdlife photography.

However, many digital imaging devices utilized in such fields or for such purposes use digital zooming technology resulting in lower resolution zoomed-in images. Digital zoom uses fewer pixels to create the zoomed-in image than the original field-of-view image, and thus digitally zoomed-in images lack the detail necessary to accurately represent a target site, such as a target surgical field in ocular or neurosurgery. Even in instances where the low resolution does not obscure or distort the target site or a feature thereof, the loss of accuracy in the representation can hinder precision in delicate procedures such as microsurgeries.

In contrast, described herein are simplified high-resolution electronically-zoomable real-time digital image capture systems, apparatus, and methods, which utilize electronic zooming capabilities and variable density displays. Such electronic zooming of a field of view results in no or little loss of resolution. Although the exemplary embodiments and methods described herein all include electronic zooming of a broad first field of view, some embodiments can also include digital or traditional non-electronic optical zoom capabilities that can be used in conjunction with the one or more electronic zoom mechanisms. Moreover, some exemplary embodiments and methods have the ability to pan or micro-navigate the electronically-zoomed fields of view. Additionally, the electronic high-resolution real-time image capture apparatus and methods can also provide improved depth of field over that of typical microscope oculars, in some embodiments at least twice the depth of field.

To date, sensor resolution increases have been implemented in industry faster than display resolution increases. Accordingly, economical displays have significantly lower resolution (i.e., fewer pixels) than economical sensors. The exemplary embodiments and methods exploit this resolution disparity by sub-sampling a higher-resolution sensor down to the resolution of the display used. By keeping the resolution of the sensor sub-sampling substantially the same as the display resolution, pixel-accurate display of the sampled pixels is possible. In some embodiments, the aspect ratio of the sensor sub-sampling is also maintained substantially the same as the display aspect ratio.

Broadly, an exemplary embodiment incorporates four primary elements that illustrate these beneficial features: at least one image sensor; at least one processor which controls the sensor, processes image data, and transports the data to a display; at least one display; and at least one electronic zoom mechanism. These elements can be physically combined into a single device or can be linked as physically separate elements within the scope and teachings of the present disclosure as required by the specific procedure being practiced.

An exemplary simplified high-resolution electronically-zoomable real-time digital image capture system can incorporate the basic structural components of the Applicant's TrueVision Systems, Inc. real-time 3D high-definition visualization apparatus described in the Applicant's co-pending U.S. applications: Ser. No. 11/256,497 entitled “Stereoscopic Image Acquisition Device,” filed Oct. 21, 2005; Ser. No. 11/668,400 entitled “Stereoscopic Electronic Microscope Workstation,” filed Jan. 29, 2007; Ser. No. 11/668,420 entitled “Stereoscopic Electronic Microscope Workstation,” filed Jan. 29, 2007; Ser. No. 11/739,042 entitled “Stereoscopic Display Cart and System,” filed Apr. 23, 2007; and Ser. No. 12/417,115, entitled “Apparatus and Methods for Performing Enhanced Visually Directed Procedures Under Low Ambient Light Conditions,” filed Apr. 2, 2009; all of which are fully incorporated herein by reference as if part of this specification.

The electronic high-resolution image capture systems, apparatus, and methods described herein are used to provide a user with a real-time digital visualization of at least a portion of a target site. Exemplary target sites visualized with the image capture apparatus can include, but are not limited to: target surgical fields such as those in neurosurgery or ocular microsurgery; sites of medical or dental procedures; cellular, molecular, or biological research sites; astronomical sites; sites used in mapping, navigation, or cartography; underwater sites; low-visibility sites; microprocessing/micro-assembly sites; wildlife-viewing or bird-viewing sites; or long distance scenery sites. If used in surgery or medical or dental procedures, the electronic high-resolution image capture apparatus allows surgeons, medical or dental practitioners, or surgical, medical or dental teams to operate or work by looking at the real-time images on the display and/or to record the procedures.

“Real-time” as used herein generally refers to the updating of information at essentially the same rate as the data is received. More specifically, “real-time” is intended to mean that image data is acquired, processed, and transmitted from an image sensor of an image capture module at a high enough data rate and at a low enough time delay that when the data is displayed, objects presented in a visualization move smoothly without user-noticeable judder, latency or lag. Typically, this occurs when the processing of the video signal has no more than about 1/10^{th} second of delay.

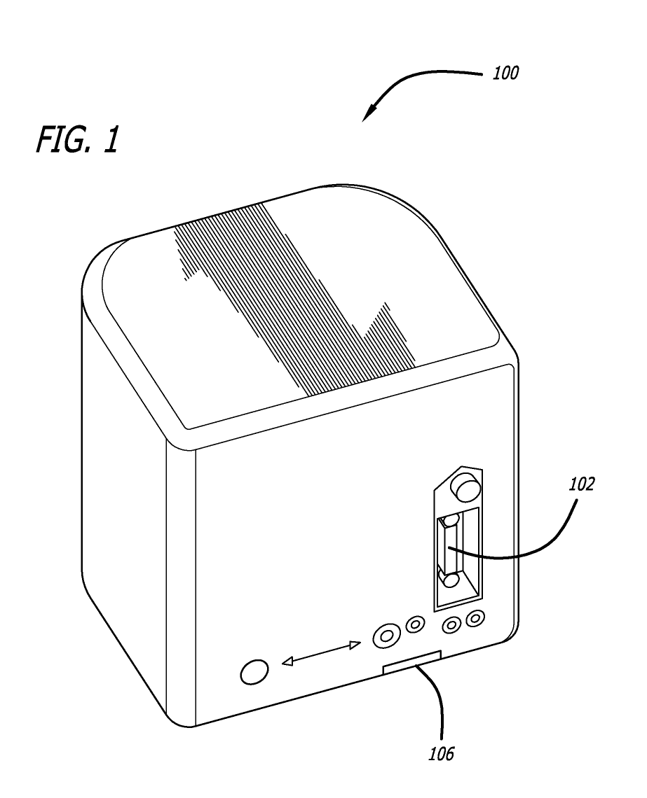

FIG. 1 illustrates an exemplary image capture module 100 that includes at least one image sensor (not shown) to capture still or video images, optionally in 3D and “high definition.” The term “high definition” or “HD” as used herein can encompass a video or still image signal having a resolution that is up to seven times higher than a standard definition (SD) signal. For purposes of the present disclosure, the display of such signals can be accomplished with, but is not limited to, display resolutions up to 1920 columns by 1080 rows (1080p) at 20 frames per second for each eye or more. In some embodiments signals can be refreshed at more than 20 frames per second, for example, without limitation, 30 frames per second. Alternatively, the display resolution can be 1280 columns by 720 rows (720p) at 60 frames per second. In another embodiment, the display resolution can be 1280 columns by 972 rows (972p) at 45 frames per second. In contrast, standard definition (SD) video typically has a resolution of 640 columns by 480 rows at 30 frames per second (480i) or less.

As those of ordinary skill in the art will appreciate, an image sensor is an electromagnetic device that has at least one energy receiving surface that responds to light and produces or converts light energy into electrical or video signals that can be transmitted to a receiver for signal processing or other operations and ultimately read by an instrument or an observer. The energy receiving surface is typically divided into a number of pixels, with the resolution of the sensor being related to the total number of such pixels. The still or video images derived from the electrical or video signals are also comprised of pixels corresponding to those of the energy receiving surfaces.

In order to generate colored images, some image capture devices utilize single image sensors in conjunction with colored filters (for example, but not limited, to Bayer filters) to generate colored light signals associated with each pixel. Accordingly, when used together, a single image sensor and a colored filter or filters (for example, arranged in an array with one color placed over each light-sensing element) can create an array of colored pixels, for example without limitation, an array of red, green, and blue pixels. Light from an array of neighboring colored pixels is mixed (for example, but not limited to, by using Bayer demosaicing) to generate color values for each pixel (for example, red, green and blue values), resulting in a colored image with colored components (for example, red, green and blue components) at each pixel location.

Alternatively, colored images can be created by image capture devices that utilize multiple image sensors or layered pixels. Image capture devices that utilize multiple image sensors (for example, three-chip cameras) have color-specific image sensors that each only generates signals for a particular color (for example without limitation, one image sensor generates red signals, one image sensor generates green signals, and/or one image sensor generates blue signals). The signals from each of the red, green, and blue image sensors are then combined to generate a colored image. Alternatively, image capture devices (for example without limitation, Foveon X3 Fx17-78-F13 Image Sensor) can utilize layered pixels to capture a complete color representation (for example without limitation, red, green and blue) at each pixel.

The scope of the systems, apparatus, and methods described herein includes use with a single image sensor image capture device or a multiple image sensor image capture device that can produce colored images by utilizing colored filters, color-specific image sensors, and/or layered pixels. Accordingly, the term “pixel” as used herein includes pixels of single-image, single-color-per-pixel image sensors, multiple image sensors (such as those image sensors used in three-chip cameras), and single-image, multiple-color-per-pixel image sensors. For each of these examples, color spaces other than red, green, and blue can also be used, for example without limitation, cyan, yellow, green, and/or magenta.

In exemplary embodiments with a plurality of image sensors, the real-time still or video images produced by different image sensors can also illustrate different views of the same target site, for example images of the target site taken from different angles or perspectives. Some of the video and still images produced and displayed by the system, apparatus, and methods described herein, can be used in conjunction with software that coordinates the images produced by different image sensors to present a seamless real-time visualization of the target site from different angles, perspectives, or views.

The embodiments described herein use signals from the image sensors to produce still or video images which can be displayed on one or more displays. “Display,” as used herein, can refer to any device capable of presenting a still or video image. The displays of the present disclosure can present real-time HD video or still images or videos which provide a surgeon, other medical practitioner, or other user with a greater level of detail than a SD signal. It is however, within the scope of the present description that the visualization can be in SD. In addition, real-time images or video can be in 24-bit color. Further, the brightness, contrast, and color saturation of the display can be digitally enhanced to the preference of the user.

Exemplary displays include HD monitors, cathode ray tubes, projection screens, liquid crystal displays, organic light emitting diode displays, plasma display panels, light emitting diodes, 3D equivalents thereof and the like. In some embodiments, 3D HD display systems (particularly, 3D HD holographic display systems) are considered to be within the scope of the present disclosure. In one embodiment, the display incorporates the basic structural components of the Applicant's TrueVision Systems, Inc. stereoscopic image display cart described in the Applicant's co-pending U.S. application: Ser. No. 11/739,042. In addition, the at least one display can be a HD monitor, such as one or more liquid crystal displays (LCD) or plasma monitors, depicting a 3D HD picture or multiple 3D HD pictures.

An image produced by an electrical or video signal can be defined by some portion or sub-sampling of the pixels defining the energy receiving surface that produces that signal. The portion of pixels utilized to produce a signal for field of view of the target site is related to a defined number of fields of view (N) produced by an image capture device. For example, if an energy receiving surface has a resolution of X pixels, the portion of pixels for a field of view signal is no more than X/N. In some embodiments, the field of view signal can be a smaller portion of the energy receiving surface's pixels, for example, but not limited to, X/(N+1) or X/N².

In one exemplary embodiment, in order to produce HD images, an image sensor can have, but is not limited to having, an energy receiving surface of at least 4.95 megapixels (e.g., 2560×1944). The one or more images produced by the signals from energy receiving surfaces can be comprised of portion of X/N or fewer of those pixels. For example, if an image capture devices is used to present two fields of view of a target site (i.e., N=2), the resulting images could have X/2 or X/4 pixels. Where the defined fractional portion is about one quarter (or X/4), the resulting images can each have 1.24 megapixels (e.g., 1280×972).

It is within scope of the present disclosure for the energy receiving surface to have other densities of pixels, including densities both more than and fewer than 4.95 megapixels. For example, pixel density can be about 5 megapixels, about 8 megapixels, about 10 megapixels, about 14 megapixels, about 20 megapixels, about 30 megapixels or more. In addition, the pixel density can be about 4 megapixels, about 2 megapixels, about 1 megapixel or less. In one example the energy receiving surface may have 11 megapixels and provide three fields of view by sub-sampling X/(3²) pixels to deliver an image of about 1.23 megapixels (1280×960). It is also within the scope of the present disclosure for images to be defined by fractions other than one quarter, such as, without limitation, one half, one third, one ninth, one twenty-fifth, or one hundredth.

While some embodiments can utilize an image capture module that provides a user, such as a surgeon, with a real-time 3D visualization of at least a portion of the target site, it is contemplated as being within the scope of the present disclosure for the display to present a real-time 2D visualization. Nonetheless, stereoscopic 3D displays can provide many benefits to the user including more effective visualization and increased depth of field.

Communication with exemplary image capture module 100 as shown in FIG. 1, including control thereof and display output from image capture module 100 as well as power to image capture module 100 can preferably be provided by a Power over Camera Link (PoCL) connector 102. However, it is within the scope of the present disclosure that communication with image capture module 100, including control thereof and display output therefrom, can be provided separately from the power supply to image capture module 100. Additionally, image capture module 100 can manually control the transmitted light intensity using iris slider switch 106. The exposure can also be either automatically or manually changed, either via the mechanical iris or via the electronic exposure time controls on the sensor(s).

The simplified high-resolution electronically-zoomable real-time digital image capture apparatus with variable density display can be used in many settings, including for example, in an examination room or an operating room. The exemplary apparatus can include various optical or electronic magnification systems including stereomicroscopes, binoculars, or telescopes, or it can function as open surgery apparatus utilizing cameras and overhead visualizations with or without magnification.

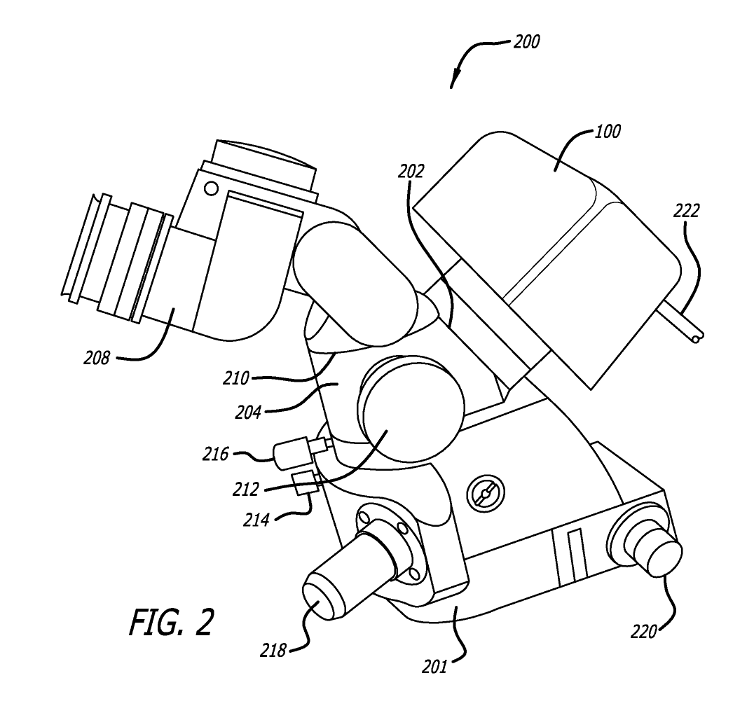

The real-time digital image capture apparatus with variable density display described herein can be a stand alone device. Alternatively, it can be embodied in a single device retrofitted onto existing equipment such as binoculars, telescopes, microscopes, or open surgery apparatus. FIG. 2 illustrates retrofitted surgical microscope 200 incorporating image capture module 100 retrofitted thereto. This is advantageous because retrofit embodiments can be added to existing systems, allowing expensive equipment to simply be upgraded as opposed to purchasing an entirely new system.

The use of a surgical microscope in combination with apparatus setup 100 allows a surgeon to comfortably visualize a surgical procedure on one or more displays instead of looking for, in some cases, several hours though the eyepiece of a surgical microscope. Retrofitted surgical microscope 200 includes image capture module 100 coupled to first ocular port 202 on ocular bridge 204. Ocular bridge 204 couples binocular eyepiece 208 to ocular port 210. Another optional ocular port 212 is available for further additions to retrofitted surgical microscope 200. Although retrofitted surgical microscope 200 includes image capture module 100, it still retains the use of conventional controls and features such as, but not limited to, iris adjustment knob 214, first adjustment knob 216 (for example, but not limited to, for focus), second adjustment knob 218 (for example, but not limited to, for optical zoom), illumination control knob 220, and an objective lens (not shown). Further still, image capture module 100 can send and receive information and be supplied with power through a single PoCL 222.

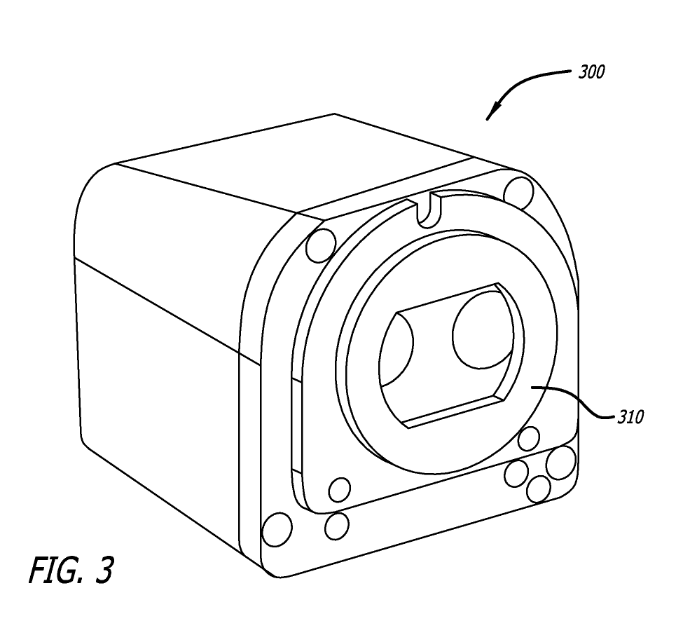

FIG. 3 shows an exemplary embodiment of an optical mount 310 to fit an exemplary image capture module 300 to a surgical microscope, such as a stereomicroscope, or other existing equipment such as a telescope.

The at least one electronic zoom mechanism of the high-resolution digital image capture apparatus with variable density display described herein allows the real-time display of a still or video image of a target site to be quickly zoomed-in with little or no loss of resolution. In some embodiments, the target site, such as a target surgical field, can be electronically zoomed-in by a factor of two or more. In one embodiment, 2× electronic zoom in each the horizontal and vertical direction uses X/4 of the X pixels of the energy receiving surface. But, because the broad, first field view also uses X/4 pixels, pixelation (also described as spatial quantization) in the zoomed-in field of view is no worse than in the broad, first field of view. In addition, the field of view can be electronically zoomed-in without the need to refocus or adjust illumination or alignment.

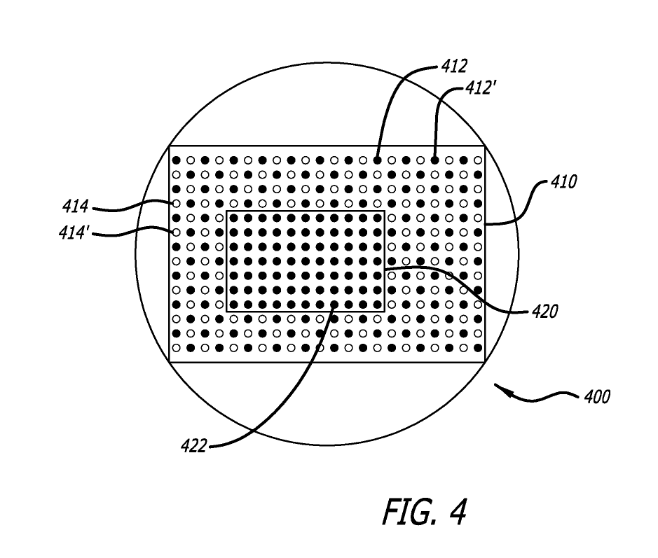

FIG. 4 is a non-limiting exemplary schematic overview 400 of broad first field of view 410 and zoom field of view 420 when using electronic zoom. The signal generating broad first field of view 410 is comprised of a certain number of non-adjacent active pixels 412, 412′. The term “non-adjacent pixels” as used herein generally refers to pixels not contiguous with one another in at least one direction. For example, non-adjacent active pixels 412, 412′ are only contiguous with other pixels along a diagonal, but are not contiguous with pixels in adjacent rows or columns (e.g., every other pixel in each row and every other pixel in each column). In other embodiments, non-adjacent pixels can be non-contiguous with other pixels in all directions or separated from each other by more than one other pixel in at least one direction, or both. For example, without limitation, in some embodiments the first or zoom field of view signals could comprise input from every third pixel in each row and every third pixel in each column, or every fifth pixel in all directions including the diagonal, or every tenth pixel in every other column, and or any other arrangement of pixels that are non-contiguous in at least one direction. This disclosure is not limited to field of vision images derived from signals with input from non-adjacent pixels that are symmetrically and repetitively arranged, but encompasses arrangements that are non-symmetrically and/or non-repetitively arranged.

As shown in FIG. 4, the total number of pixels of the energy receiving surface includes both non-adjacent active pixels 412, 412′ and non-active pixels 414, 414′ i.e., the defined number of pixels (X) includes all of 412, 412′, 414, and 414′. Additionally, FIG. 4 shows two fields of view, broad first field of view 410 and zoom field of view 420, thus N=2. In some embodiments, the aspect ratio for each of the N fields of view can be substantially the same. Non-limiting exemplary schematic overview 400 shows that the number of non-adjacent active pixels 412, 412′ that generate input for the broad first field of view 410 can be X/2, or half.

The signal generating zoom field of view 420 is comprised of adjacent pixels 422. The number of adjacent pixels 422 in zoom field of view 420 is X/N or fewer, i.e., in FIG. 4 half or less than half of the defined number of pixels of the energy receiving surface. As shown, the number of adjacent pixels 422 is less than X/N, here X/4. In other embodiments, the number of adjacent pixels 422 can be the same as the number of non-adjacent active pixels 412, 412′ in broad field of view 410, e.g., half of the defined number of pixels of the energy receiving surface. Because fewer pixels than the defined number of the energy receiving surface are used to generate broad first field of view 410 and zoom second field of view 420, the loss of resolution typically caused by digital zooming is reduced.

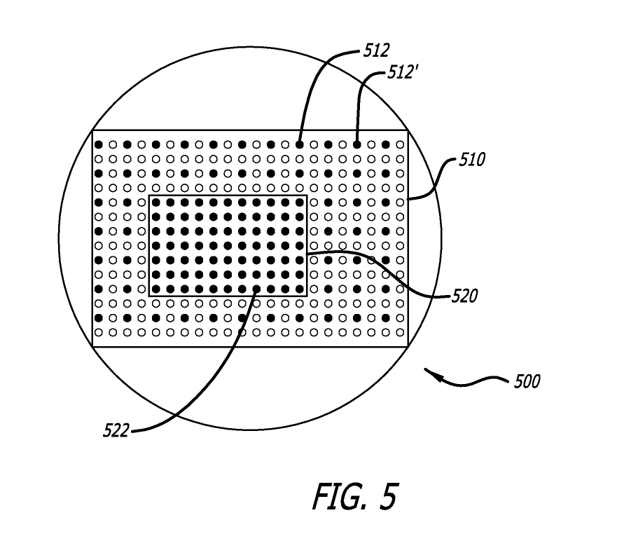

FIG. 5 is another non-limiting exemplary schematic overview 500 of broad first field of view 510 and zoom field of view 520 where each of broad first field of view 510 and zoom field of view 520 is derived from a signal of X/N² pixels. The signal generating broad first field of view 510 is comprised of a certain number of non-adjacent active pixels 512, 512′ that are non-contiguous in any direction (e.g., every other pixel in every other row, or every other pixel in every other column). Non-limiting exemplary schematic overview 500 shows two fields of view, broad first field of view 510 and zoom field of view 520, thus, N=2. Accordingly, non-adjacent active pixels 512, 512′ represent one quarter, i.e., X/N², of the total number of pixels of the energy receiving surface. The signal generating zoom field of view 520 is comprised of adjacent pixels 522, and the number of adjacent pixels 522 is also one quarter of the total number of pixels, i.e., substantially the same as the number of pixels generating broad first field of view 510. For example, where the defined number of pixels is at least 4.95 megapixels (e.g., at least 2560×1944 pixels), the images for both the broad first field of view and the zoom field of view can have, for example, and depending on the portion of pixels sub-sampled, at least 1.24 megapixels (e.g., 1280×972 pixels). Because the number of pixels generating both broad first field of view 510 and zoom field of view 520 is substantially the same, there is little or no loss of resolution, and the target site can be visualized in greater detail enabling a user to work with improved accuracy.

In addition, FIG. 5 shows that the relative spacing of the pixels used to compose the image for each of broad first field of view 510 and zoom field of view 520 is substantially the same to within a constant scalar, providing an image with a substantially constant aspect ratio for each field of view.

In some embodiments, the energy receiving surface has a high enough density of pixels for there to be more than one zoom field of view, with each zoom field of view showing a more detailed and magnified part of the target site at substantially the same resolution and/or aspect ratio as the broad field of view. For example, but without limitation, in some embodiments, there can be four fields of view, one first field of view and three zoom fields of view; in other embodiments there can be a total of ten fields of view, with nine zoom fields of view.

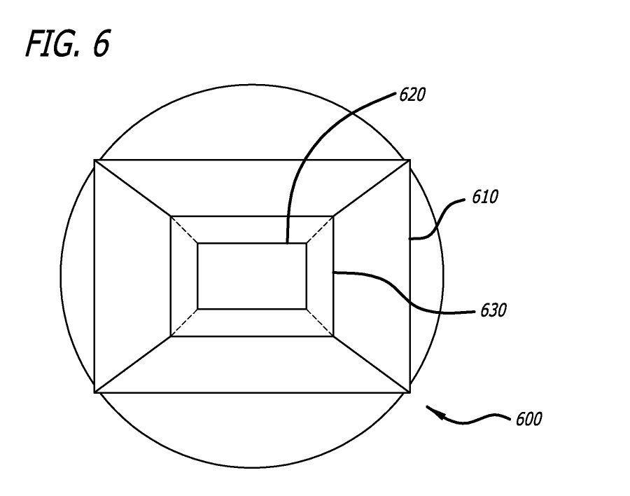

FIG. 6 shows an exemplary schematic overview 600 of three fields of view. Each of first field of view 610, a additional zoom field of view 630, and a zoom field of view 620 is derived from a signal comprising input of the same portion of active pixels, where that portion is no more than one third (where N, the number of fields of view, is 3) of the pixels of the one or more energy receiving surface (X). The disclosure covers active pixel portions of the energy receiving surface pixels equivalent to X/3 and all portions less than X/3, including, but not limited to, portions of X/9. Each field of view image is generated by a signal comprising input from active pixels closer and closer together. For example, additional zoom field 630 is comprised of input from X/3 or fewer active pixels that are closer together than the X/3 or fewer active pixels that generate the first field of view 610 signal. To achieve this, signals from active pixels can be averaged (or “binned”) with signals from non-active pixels, or non-active pixels can be skipped. In some embodiments, the centers of the active pixels of each field of view are successively closer and closer together, i.e. the centers of the active pixels generating additional zoom field 630 will be closer together than the centers of the active pixels generating first field of view 610. Similarly, input for a zoom field of view 620 signal is from X/3 or fewer active pixels that are closer together than the X/3 or fewer active pixels that generate additional zoom field of view 630 signal. In some embodiments, the X/3 active pixels that generate zoom field of view 620 signals are adjacent, and the X/3 active pixels that generate additional zoom field of view 630 are non-adjacent. The X/3 active pixels that generate zoom field of view 620 can have centers that are closer together than the centers of the active pixels generating additional zoom field 630.

Because each zoom field of view is generated by active pixels, the centers of which are located closer together, the size of each zoom field of view in relation to the first field of view decreases. For example, if zoom fields (Z) are numbered in order of progressive levels of zoom, for N fields of view, the size of each zoom field of view is (N−Z)²/N² times the size of the broad first zoom field of view. For example, without limitation, for three fields of view, the first zoom field of view (Z=1) is 4/9^{th} the size of the first field of view and the second zoom field of view (Z=2) is 1/9^{th} the size of the first field of view. Similarly, for four fields of view, the first zoom field is 9/16^{th}, the second zoom field is 4/16 (or one quarter), and the third zoom field is 1/16^{th} size of the first field of view.

In some embodiments, the high-resolution electronically-zoomable real-time image capture apparatus with variable density display described herein can include three or more fields of view, for example without limitation, a broad field of view and at least two zoom fields of view. Each zoom field of view can provide a more magnified image of a portion of the broad first field of view or the less magnified zoom field of view at substantially the same resolution for the fourth, fifth, sixth, seventh and more fields-of-view. In certain embodiments, the aspect ratio for each field of view can also be substantially the same.

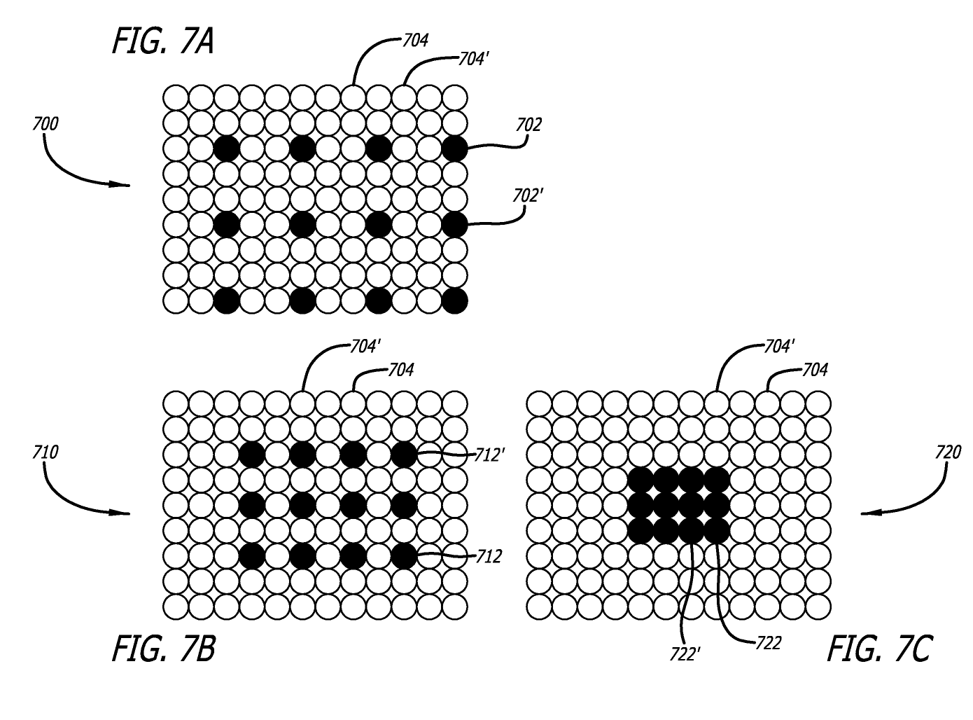

FIGS. 7A, 7B, and 7C illustrate three exemplary fields of view. FIG. 7A illustrates broad field of view 700 derived from signals from non-adjacent active pixels, 702, 702′. As shown, there are twelve non-adjacent active pixels 702, 702′ each separated from each other by two non-active pixels 704, 704′ in each direction (e.g., active pixels 702, 702′ are in every third row and every third column). Where the total number of pixels of an energy receiving surface (X) is composed of all of 702, 702′, 704, and 704′, non-adjacent active pixels 702, 702′ represent X/N², or X/9 for three fields of view.

FIG. 7B illustrates zoom field of view 710 derived from signals from non-adjacent active pixels 712, 712′ closer together than the non-adjacent active pixels 702, 702′ of broad field of view 700. Non-adjacent active pixels 712, 712′ of zoom field of view 710 are each separated from each other by one non-active pixel 704, 704′ in each direction. As in FIG. 7A, there are twelve non-adjacent active pixels 712, 712′, which represent one-ninth of the total number of pixels of an energy receiving surface (X). In certain embodiments, the centers of non-adjacent active pixels 712, 712′ can be closer together than the centers of non-adjacent active pixels 702, 702′ of broad field of view 700 in FIG. 7A.

FIG. 7C illustrates zoom field of view 720 comprised of adjacent active pixels 722, 722′. As in FIGS. 7A and 7B, there are twelve adjacent active pixels 722, 722′, which represent one-ninth of the total number of pixels of an energy receiving surface (X).

Because each field of view 700, 710, and 720 is comprised of the same fractional portion (e.g., but not limited to, one ninth) of the defined number of pixels X, each field of view has substantially the same resolution. Therefore, even though zoom field of view 720 provides more detail of a portion of the target site than in zoom field of view 710 or broad field of view 700, the resolution of each field of view will be substantially the same. In addition, the relative spacing of the pixels used to compose the image for each field of view 700, 710, 720 is substantially the same to within a constant scalar, providing an image with a substantially constant aspect ratio for each field of view.

In some exemplary embodiments and methods, a portion of no more than X/N non-adjacent active pixels can be used to generate a field of view image without skipping the non-active pixels of an energy receiving surface. This alternative to skipping rows and columns of non-active pixels, utilizes an average of signals from an active pixel and its adjacent non-active pixels to generate a single pixel of a field of view image. This averaging alternative to skipping non-active pixels is known to those of ordinary skill in the art as binning. Image sensors used in binning embodiments of the present disclosure can use, but are not limited to, sensors such as Aptina's MT9J401 or the like.

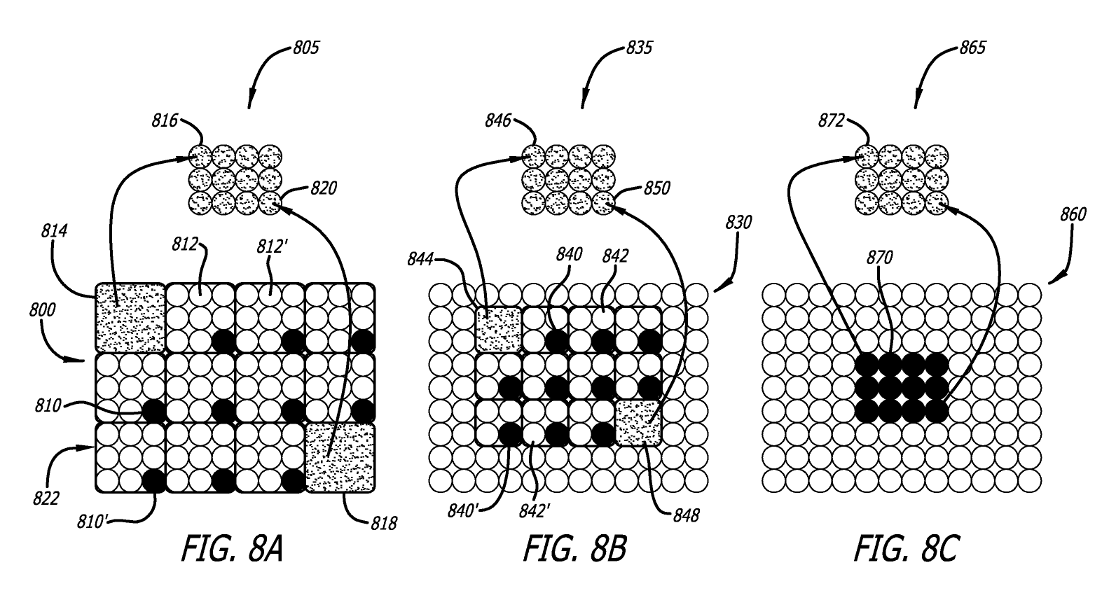

FIGS. 8A, 8B, and 8C are exemplary schematics of a broad first field of view and two zoom fields of view where binning is used. FIG. 8A illustrates an exemplary embodiment in which input from non-adjacent active pixels for first field of view 800 signal is composed of average signals 814, 818 from a portion of non-adjacent active pixels 810, 810′ and their adjacent non-active pixels 812, 812′. As shown, first field of view image 805 has X/N² (e.g., twelve pixels) including pixels 816 and 820, and is derived from signals with input from X/N² (e.g., twelve) non-adjacent active pixels 810, 810′. However, instead of skipping adjacent non-active pixels 812, 812′, the sensor averages the pixels in neighborhood 822 to create a single pixel value for each neighborhood 822, i.e., average signals 814, 818. Each of the X/N² average signals is calculated from one non-adjacent active pixel, e.g. 810, and (N²−1) non-active pixels adjacent to the active pixel, which together form neighborhood 822. The sensor repeats this for all X/N² neighborhoods, reading average signals 814, 818 from each neighborhood 822 surrounding active pixels 810, 810′. Thus average signal 814 from one neighborhood generates image pixel 816 and average signal 818 from a different neighborhood generates image pixel 820 of first field of view image 805.

FIG. 8B illustrates zoom field of view 830 with X/N² (e.g., twelve) non-adjacent active pixels 840, 840′ and their respective adjacent non-active pixels 842, 842′. Zoom field of view image 835 is derived from averaged (or binned) signals from non-adjacent active pixels 840, 840′ and their adjacent non-active pixels 842, 842′, such that average signal 844 generates image pixel 846 and average signal 848 generates image pixel 850. FIG. 8B also indicates how non-adjacent active pixels 840, 840′ used to generate zoom field of view image 835 are closer together than non-adjacent active pixels 810, 810′ of FIG. 8A. The centers of non-adjacent active pixels 840, 840′ can, in certain embodiments, be closer together than the centers of non-adjacent active pixels 810, 810′ of FIG. 8A.

FIG. 8C illustrates a zoom field of view 860 comprised of X/N² (e.g., twelve) adjacent active pixels 870. Accordingly, zoom field of view image 865 is derived without binning, and signals from adjacent active pixels 870 directly generate pixels 872 of zoom field of view image 865.

In one non-limiting exemplary embodiment, if the defined number of pixels of an image sensor is 3840×2880 (or about 11 megapixels), and the display is about 1280×960 pixels the systems, apparatus, and methods described herein would allow for several, non-limiting field of view images. For example, a broad first field of view can be comprised from 11/3 or fewer active megapixels, for example 11/9 active megapixels such that the broad first field of view image has a net resolution of 1280×960 pixels. This can be achieved by either skipping or binning 2 of 3 pixels in both the horizontal and vertical directions. In addition, a zoom field of view can be comprised of 11/3 or fewer active megapixels. For example, by skipping or binning every alternate pixel in both the vertical and horizontal directions, 11/9 active megapixels could generate a 1280×960 zoom field of view. Additionally, this zoom field of view can be further magnified by using 11/9 active adjacent megapixels to generate another, more magnified zoom field of view.

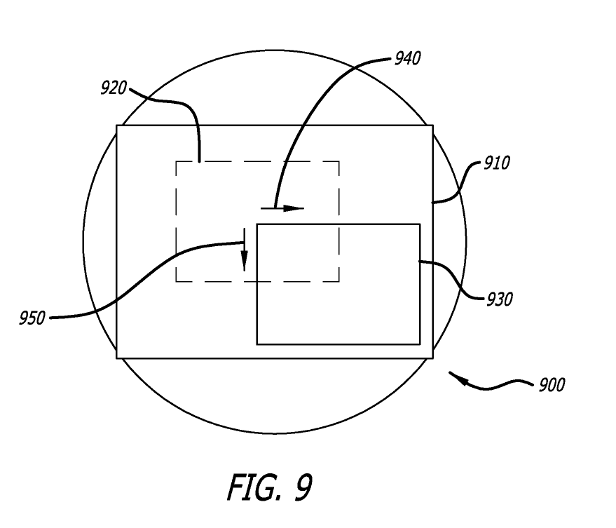

Some exemplary embodiments and methods include an electronic panning mechanism, which allows for real-time micro-navigation of at least one zoom field of view. FIG. 9 is an exemplary schematic overview 900 of the panning capability of zoom field of view 920. The figure illustrates broad first field of view 910 comprised of a defined number of non-adjacent active pixels and zoom field of view 920 comprised of substantially the same number of active pixels. The electronic panning mechanism of the exemplary embodiments enables a user to move zoom field of view 920 from one area of the target field shown in broad first field of view 910 to another area of the target field 930 using horizontal panning 940 and/or vertical panning 950. In this way, broad first field of view 910 can be micro-navigated. Moreover, any combination of panning can be used, and panning can include single pixel transitions. Additionally, such micro-navigation can be achieved without needing to refocus or adjust illumination.

If there is more than one zoom field of view, the electronic panning mechanism can micro-navigate any or all of the zoom fields of view. The electronic panning mechanism can be used to move each zoom field of view within the first field of view or any less-magnified or less-zoomed in field of view so as to micro-navigate the target site at different zoom views. For example, a third zoom field of view can micro-navigate a second zoom field of view as well as the broad first field of view. Moreover, in embodiments comprising more than one image sensor each producing one or more image streams of different angles, perspectives, or views, the panning mechanism is capable of panning between the broad and zoom field views of each image stream.

Navigation or control of the electronic panning mechanism can be achieved by using a controller such as a lever, toggle, switch, dial, keyboard, mouse, joystick, foot pedals, touch screen device, remote control, voice activated device, voice command device, or the like. This allows the user to have direct control over micro-navigating the field of view.

In addition to the resolution of the display, depth of field is particularly important in providing accurate visualization of target sites, for example an eye's topography in ocular microsurgery. “Depth of field” as used herein generally refers to the range of distances at which an object will appear in focus in an image. When depth of field is increased, objects or features at further distances can still appear focused in an image or video. In some embodiments, depth of field of the still or video images produced by the electronic high-resolution image capture system described herein is up to twice that of microscope oculars.

Users in a wide variety of fields, including without limitation medical practitioners, will find that the apparatus disclosed herein provides many advantages over existing technology. The present disclosure provides apparatus which can allow users to view target areas, such as target surgical fields, with greater depth of field and better resolution. In addition, users can electronically zoom in and pan zoomed-in fields of view without having to refocus or adjust illumination. The embodiments described herein can either be incorporated into stand-alone image capture devices or retrofitted to other existing equipment, including but not limited to, microscopes, binoculars, or telescopes.

Unless otherwise indicated, all numbers expressing quantities and/or properties such as resolution and so forth used in the specification and claims are to be understood as being modified in all instances by the term “about.” Accordingly, unless indicated to the contrary, the numerical parameters set forth in the specification and attached claims are approximations that may vary depending upon the desired properties sought to be obtained by the present disclosure. At the very least, and not as an attempt to limit the application of the doctrine of equivalents to the scope of the claims, each numerical parameter should at least be construed in light of the number of reported significant digits and by applying ordinary rounding techniques. Notwithstanding that the numerical ranges and parameters setting forth the broad scope of the disclosure are approximations, the numerical values set forth in the specific examples are reported as precisely as possible. Any numerical value, however, inherently contains certain errors necessarily resulting from the standard deviation found in their respective testing measurements.

The terms “a,” “an,” “the” and similar referents used in the context of describing the exemplary embodiments (especially in the context of the following claims) are to be construed to cover both the singular and the plural, unless otherwise indicated herein or clearly contradicted by context. Recitation of ranges of values herein is merely intended to serve as a shorthand method of referring individually to each separate value falling within the range. Unless otherwise indicated herein, each individual value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein is intended merely to better illuminate the exemplary embodiments and does not pose a limitation on the scope of the exemplary embodiments otherwise claimed. No language in the specification should be construed as indicating any non-claimed element essential to the practice of the exemplary embodiments.

Groupings of alternative elements or embodiments disclosed herein are not to be construed as limitations. Each group member may be referred to and claimed individually or in any combination with other members of the group or other elements found herein. It is anticipated that one or more members of a group may be included in, or deleted from, a group for reasons of convenience and/or patentability. When any such inclusion or deletion occurs, the specification is deemed to contain the group as modified thus fulfilling the written description of all Markush groups used in the appended claims.

Certain embodiments are described herein, including the best mode known to the inventors for carrying out the exemplary embodiments. Of course, variations on these described embodiments will become apparent to those of ordinary skill in the art upon reading the foregoing description. The inventor expects skilled artisans to employ such variations as appropriate, and the inventors intend for the embodiments to be practiced otherwise than specifically described herein. Accordingly, this disclosure includes all modifications and equivalents of the subject matter recited in the claims appended hereto as permitted by applicable law. Moreover, any combination of the above-described elements in all possible variations thereof is encompassed by the disclosure unless otherwise indicated herein or otherwise clearly contradicted by context.

Furthermore, numerous references have been made to patents and printed publications. Each of the above-cited references is individually incorporated herein by reference in their entirety.

Specific embodiments disclosed herein may be further limited in the claims using consisting of or and consisting essentially of language. When used in the claims, whether as filed or added per amendment, the transition term “consisting of” excludes any element, step, or ingredient not specified in the claims. The transition term “consisting essentially of” limits the scope of a claim to the specified materials or steps and those that do not materially affect the basic and novel characteristic(s). Exemplary embodiments so claimed are inherently or expressly described and enabled herein.

In closing, it is to be understood that the exemplary embodiments disclosed herein are illustrative of the principles of the present disclosure. Other modifications that may be employed are within the scope of the disclosure. Thus, by way of example, but not of limitation, alternative configurations of the present exemplary embodiments may be utilized in accordance with the teachings herein. Accordingly, the present exemplary embodiments are not limited to that precisely as shown and described.

I claim:

1. An electronic high-resolution image capture apparatus comprising:
at least one image sensor having an energy receiving surface with a defined number of pixels (X) for producing at least one signal;
at least one display for presenting a defined number of fields of view (N), wherein each of said fields of view is comprised of at least one image derived from said at least one signal; and
an electronic zoom mechanism for switching between N fields of view presented by said display, wherein a first field of view signal is comprised of input from no more than X/N non-adjacent active pixels of said energy receiving surface, and at least one zoom field of view signal is comprised of input from no more than X/N adjacent active pixels of at least one specific area of said energy receiving surface.

2. An apparatus according to claim 1 wherein said image is a still image or a video image.

3. An apparatus according to claim 1 wherein at least one processor controls said at least one image sensor and controls and processes said at least one signal to produce said at least one image.

4. An apparatus according to claim 1 wherein said first field of view signal is comprised of input from about X/N² non-adjacent active pixels of said energy receiving surface, and said at least one zoom field of view signal is comprised of input from about X/N² adjacent active pixels of at least one specific area of said energy receiving surface.

5. An apparatus according to claim 1 wherein said input from no more than X/N non-adjacent active pixels is composed of no more than X/N average signals, wherein each average signal is calculated from one of said no more than X/N non-adjacent active pixels and its adjacent non-active pixels.

6. An apparatus according to claim 1 further comprising at least one electronic panning mechanism for varying the location of said at least one zoom field of view.

7. An apparatus according to claim 1 further comprising a second image sensor having a second energy receiving surface with at least X pixels for producing at least one additional signal.

8. An apparatus according to claim 7 wherein said at least one additional signal produces at least one additional image of a different angle or view than said at least one image derived from said at least one signal.

9. An apparatus according to claim 1 mounted to a surgical microscope.

10. An apparatus according to claim 1 wherein said apparatus is used to view a target site selected from the group consisting of a surgical site, a site for a medical or dental procedure, a site for cellular, molecular, or biological research, an astronomical site, a mapping, cartographical, or navigation site, an underwater site, a low-visibility site, a microprocessing/micro-assembly site, a wildlife- or bird-viewing site, and a long distance scenery site.

11. An apparatus according to claim 1 wherein said at least one image derived from said at least one signal is high definition (HD) and/or three dimensional (3D).

12. An apparatus according to claim 2 wherein said at least one image derived from said at least one signal is refreshed at a rate of at least 20 frames per second.

13. An apparatus according to claim 2 wherein said still image or said video image is captured and displayed in real-time.

14. An apparatus according to claim 1 wherein said defined number of pixels (X) is at least 4.95 million pixels.

15. An apparatus according to claim 1 wherein N is at least three, and wherein at least a second zoom field of view signal is comprised of input from no more than X/N non-adjacent active pixels of at least one additional specific area of said energy receiving surface, wherein said at least a second zoom field of view non-adjacent active pixels are closer together than said first field of view non-adjacent active pixels, and said at least one zoom field of view adjacent active pixels are closer together than said at least a second zoom field of view non-adjacent active pixels.

16. An apparatus according to claim 15 wherein said first field of view signal is comprised of input from about X/N² non-adjacent active pixels of said energy receiving surface, said at least a second zoom field of view signal is comprised of input from about X/N² non-adjacent active pixels of at least one additional specific area of said energy receiving surface, and said at least one zoom field of view signal is comprised of input from about X/N² adjacent active pixels of at least one specific area of said energy receiving surface.

17. An apparatus according to claim 15 further comprising at least one electronic panning mechanism for varying the location of said at least one zoom field of view or at least a second zoom field of view.

18. A method of electronic zoom comprising the steps of:
producing a defined number of fields of view (N) presented by at least one display, wherein each field of view is an image derived from at least one signal produced by at least one image sensor having an energy receiving surface with a defined number of pixels (X);
switching between a first field view, wherein said at least one signal for said first field of view is comprised of input from no more than X/N non-adjacent active pixels of said energy receiving surface, and at least one zoom field of view, wherein said at least one signal for said at least one zoom field of view is comprised of input from no more than X/N adjacent active pixels of at least one specific area of said energy receiving surface.

19. A method of electronic zoom according to claim 18 wherein said at least one signal for said first field of view is comprised of input from about X/N² non-adjacent active pixels of said energy receiving surface, and said at least one signal for said at least one zoom field of view is comprised of input from about X/N² adjacent active pixels of said at least one specific area of said energy receiving surface.

20. A method of electronic zoom according to claim 18 wherein N is at least three, and wherein at least a second zoom field of view is comprised of input from no more than X/N non-adjacent pixels of at least one additional specific area of said energy receiving surface, wherein said at least a second zoom field of view non-adjacent pixels are closer together than said first field of view non-adjacent pixels, and said at least one zoom field of view adjacent pixels are closer together than said at least a second zoom field of view non-adjacent pixels.
